(19) United States
(12) Patent Application Publication
(10) Pub. No.: US 2016/0140249 A1
(43) Pub. Date: May 19, 2016

(54) SYSTEM AND METHOD FOR E-BOOK READING PROGRESS INDICATOR AND INVOCATION THEREOF

(71) Applicant: KOBO INCORPORATED, Toronto (CA)

(72) Inventor: Sarah FLAWN, Toronto (CA)

(73) Assignee: KOBO INCORPORATED, Toronto (CA)

(21) Appl. No.: 14/543,727

(22) Filed: Nov. 17, 2014

(51) Int. Cl. G06F 17/30; G06F 3/0488; G06F 3/0483; G06F 17/21

(52) U.S. Cl. CPC G06F 17/30876; G06F 17/217; G06F 3/0488; G06F 3/0483; G06F 17/30011

(57) ABSTRACT

Displaying e-book reading progress in a non-intrusive manner based on an exit action of a user. The exit action is received with regard to a last-read page of e-book content displayed, the e-book content being paginated in accordance with a series of digitally constructed pages including a start page and an end page. The last-read page is interposed between the start and end pages. An indicium of the e-book pages is displayed, with demarcation of a finished portion from an unfinished portion of the content.

### TECHNICAL FIELD

Examples described herein relate to a system and method for a reading progress indicator.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for invoking and displaying an indicator of e-book reading progress.

FIG. 2 illustrates a schematic architecture of a computing device configured for invoking and displaying an indicator of e-book reading progress.

FIGS. 3(a) and (b) illustrate example configurations in an operation to invoke and display an indicator of e-book reading progress, according to some embodiments.

FIG. 4 illustrates a method of operating a computing device to invoke and display an indicator of e-book reading progress, according to an embodiment.

### DETAILED DESCRIPTION

One or more embodiments described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

“E-books” are a form of electronic publication content stored in digital format in a computer non-transitory memory, viewable on a computing device having display functionality. Pages of an e-book may be digitally constructed to correspond to, or mimic, the paginated format of a printed publication for viewing, such as provided by printed literary works (e.g., novels) and periodicals (e.g., magazines, comic books, journals, etc.), wherein discrete pages comprising the electronic content are digitally constructed. Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

While consumption of e-book content via e-reading devices continues to gain popularity with consumers, one drawback concerns a perceived lack of feedback when “closing” or otherwise exiting the e-book being read. More specifically, while upon closing a paper book, a reader or observer can intuitively glance at a closed-end pages view to form an instantaneous and comprehensive image of how much of the book they have finished reading, relative to the unfinished portion remaining to be read, such intuitive “at a glance” feedback eludes the e-book reading experience.

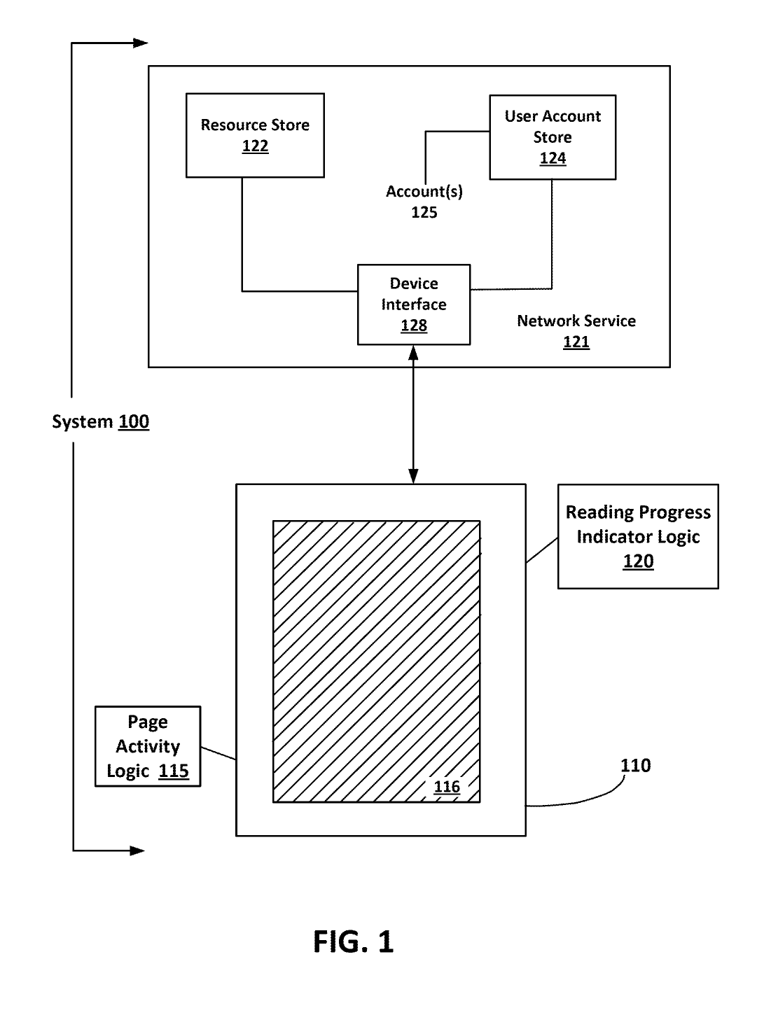

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 121. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device, but rather at an electronic library (e-library) associated with account 125.

With reference to an example of FIG. 1, e-reading device 110 can include a display screen 116 and a housing (not shown). In an embodiment, the display screen 116 is touch-sensitive, to process touch inputs including gestures (e.g., swipes). For example, the display screen 116 may be integrated with one or more touch sensors to provide a touch-sensing region on a surface of display screen 116. For some embodiments, the one or more touch sensors may include capacitive sensors that can sense or detect a human body's capacitance as input. In the example of FIG. 1, the touch-sensing region coincides with a substantial surface area, if not all, of the display screen 116. Additionally, the housing can also be integrated with touch sensors to provide one or more touch sensing regions, for example, on the bezel and/or back surface of the housing.

According to some embodiments, the e-reading device 110 includes display sensor logic to detect and interpret user input or user input commands made through interaction with the touch sensors. By way of example, display sensor logic can detect a user making contact with the touch-sensing region of the display screen 116, otherwise known as a touch event. More specifically, display sensor logic can detect a touch event also referred to herein as a tap, an initial tap held in sustained contact, or sufficiently in proximity to register a “contact”, with display screen 116 (otherwise known as a “long press”), multiple taps performed either sequentially or generally simultaneously, swiping gesture actions made through user interaction with the touch sensing region of the display screen 116, or any combination of these gesture actions. Furthermore, the display sensor logic can interpret such interactions in a variety of ways. For example, each such interaction may be interpreted as a particular type of user input associated with a respective input command, execution of which may trigger a change in state of display 116. The display sensor logic may also sense directionality of a user gesture action so as to distinguish between, for example, leftward, rightward, upward, downward and diagonal swipes along a surface portion of display screen 116 for the purpose of associating respective input commands therewith.

In some embodiments, the e-reading device 110 includes features for providing functionality related to displaying paginated content. The e-reading device 110 can include page activity logic 115, which enables the user to transition through paginated content. The e-reading device 110 can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page activity logic 115 can operate to enable the user to transition from a given page state to another page state. In the specific example embodiment where a given page state coincides with a single page, for instance, each page state corresponding to one page of the digitally constructed series of pages paginated to comprise, in one embodiment, an e-book. In some implementations, the page activity logic 115 enables single page transitions, chapter transitions, cluster transitions (multiple pages at one time), or in performing exit operations from the e-book reading experience, such as by bookmarking a last-read page, returning to a view of the user's e-library, opening another application unrelated to reading content of the e-book, and switching the device to an off-state.

The page activity logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition, e.g., from one page to next in sequence of the series of pages comprising the e-book. In another example, a user can specify page turns of different kinds or magnitudes through single taps, sequenced taps or patterned taps on the touch sensing region of the display screen 116. Although discussed in context of a touch herein, it is contemplated that a gesture action provided in sufficient proximity to touch sensors of display screen 116, without physically touching thereon, may also register as a “contact” with display screen 116, to accomplish a similar effect as a tap, and such embodiments are also encompassed by the description herein.

According to some embodiments, the e-reading device 110 includes display sensor logic to detect and interpret user input or user input commands made through interaction with the touch screen display 116, otherwise known as a touch event. More specifically, the display sensor logic can detect a touch event, an initial tap held in sustained contact, or sufficiently in proximity to register a “contact”, with display screen 116 (otherwise known as a “long press”), multiple taps performed either sequentially or generally simultaneously, swiping gesture actions made through user interaction with the touch sensing region of the display screen 116, or any combination of these gesture actions, which may initiate a change in display state of display screen 116.

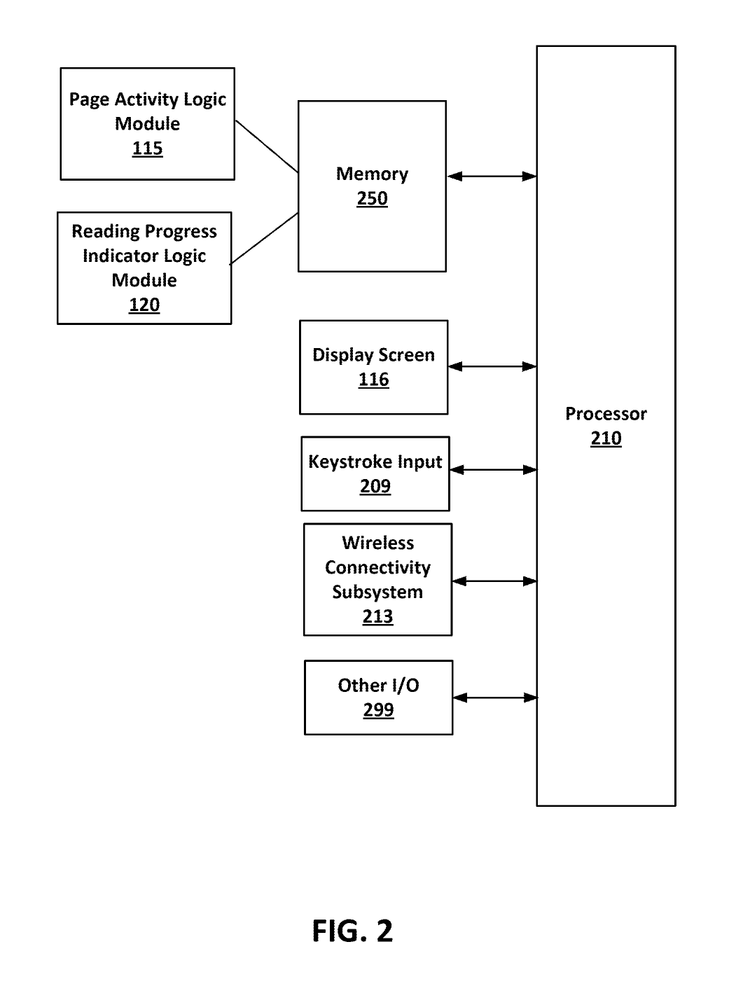

Reading progress logic module 120 of computing device 110 and page activity logic module 115 can be implemented as software modules comprising instructions stored in a memory of mobile computing device 110, as described in further detail below with regard to FIG. 2.

FIG. 2 illustrates a schematic architecture of e-reading device 110 as described above with respect to FIG. 1. E-reading device 110 further includes processor 210, a memory 250 storing instructions and logic pertaining at least to reading progress indicator module 120 and page activity module 115.

Processor 210 can implement functionality using the logic and instructions stored in memory 250. Additionally, in some implementations, processor 210 utilizes the network interface 220 to communicate with the network service 121 (see FIG. 1). More specifically, the e-reading device 110 can access the network service 121 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 121. The application resources 221 that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive, and respond to, input from various sources, including touch sensor components of display 116, keystroke input 208 such as from a virtual or rendered keyboard, and other input mechanisms 299 (e.g., buttons, mouse, microphone, etc.). In some embodiments, processor 210 responds to inputs in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

Page activity logic module 115 and Reading Progress indicator module 120 can be implemented as software modules, comprising instructions stored in memory 250 on mobile computing device 110. One or more embodiments of reading progress logic module 120 and page activity logic module 115 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

Reading progress indicator module 120 can track the progress of page transitions enacted via page activity logic 115 to calculate statistics associated with reading progress along the series of digitally constructed pages of the e-book content. For instance, based on a current page being read by an observer, reading progress indicator module 120 may conclude that the observer has finished reading a portion of the e-book having pages starting from a start page of the e-book content through that current page, or last page, being read; and likewise conclude or presume that the unfinished portion of the e-book remaining to be read comprises those pages starting from that last page read to an end page of the e-book series of digitally constructed pages.

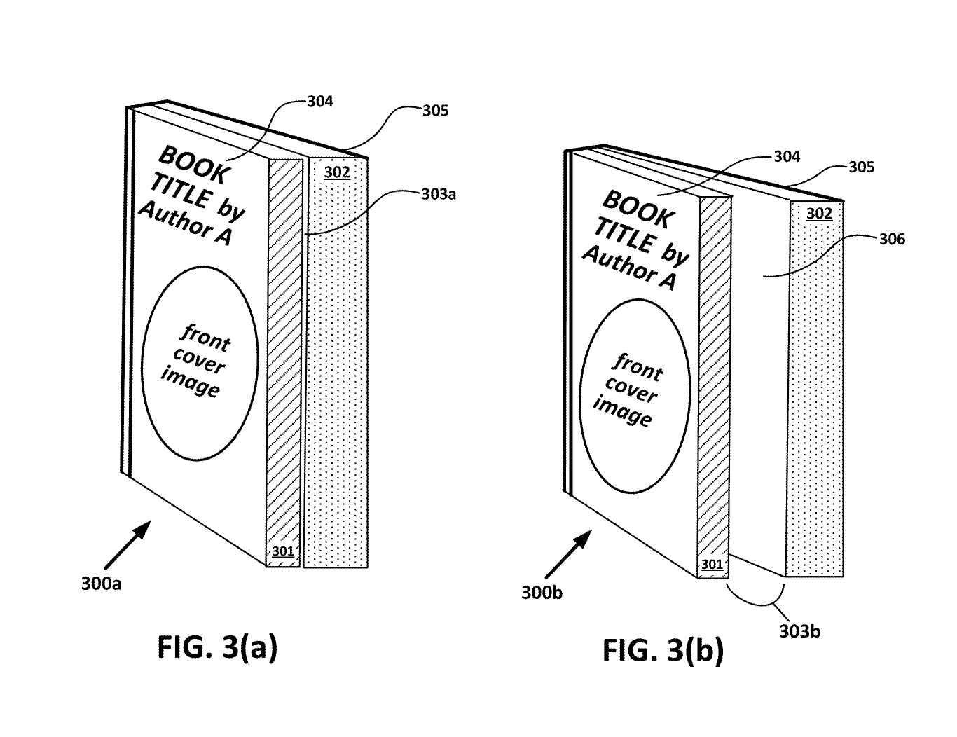

With reference now to FIG. 3(a) and FIG. 3(b), an embodiment implementation of reading progress logic module 120 in conjunction with page activity logic module 115 in operation of computing device 110 is described in further detail.

In FIG. 3(a), display screen 116 of computing device 110 renders indicium 300a, visually representing the series of pages of the e-book having a start 304 and an end page 305 according to a perspective-type view, in an embodiment. Based on receiving a reading experience exit action initiated at a last- or currently-read page, such as a bookmarking operation performed upon a touchscreen display 116, reading progress indicator module 120 may display a finished portion 301 and an unfinished portion 302 of the e-book content within indicium 300a. In one embodiment, a discontinuity 303a demarcates finished portion 301 from unfinished portion 302 of the e-book content within indicium 300a. In a variation embodiment, finished portion 301 is rendered visually differently from unfinished portion 302 as demarcated along discontinuity 303a, such as by use of different colors, brightness, shading, or other illumination aspect. In yet another embodiment, finished portion 301 mat comprise a static or solid color while in contrast, unfinished portion 302 is rendered in a pulsating or fluctuating color, “inviting” an observer to read the pages therein.

Reading progress indicator 120 may calculate the number of pages comprising finished portion 301 and unfinished portion 302, thereby to render the spatial dimensions thereof in relative proportion within indicium 300a. For instance, when an observer has only completed reading one-third of the pages of the e-book, starting with the start page, unfinished portion 302 will be accordingly rendered with twice the thickness of finished portion 301 within indicium 300a.

FIG. 3(b) shows, in another embodiment, indicium 300b where discontinuity 303b between finished and unfinished portions 301, 302 is provided by a spatial gap therebetween, such as if pages of the e-book were “opened” at a “first page” 306 of unfinished portion 302 to invite the observer to resume and continue their reading experience.

As depicted in FIGS. 3(a) and (b), indicium 300a may depict an image 304 of the front cover of the e-book that corresponds to, or mimics, a paper version of the book as published, for instant identification by way of confirmation to the observer. While FIGS. 3(a) and (b) depict a start page that coincides with the front cover image 304, it is contemplated that reading progress indicator can be programmed to recognize others of the initial pages of the e-book, such as a table of contents page, or the first page of chapter 1 substantive content, as the start page instead. It is contemplated that the device memory 250 further stores instructions and accesses metadata to enact the graphical images as front cover 304 within indicium 300a and 300b rendered on display screen 116.

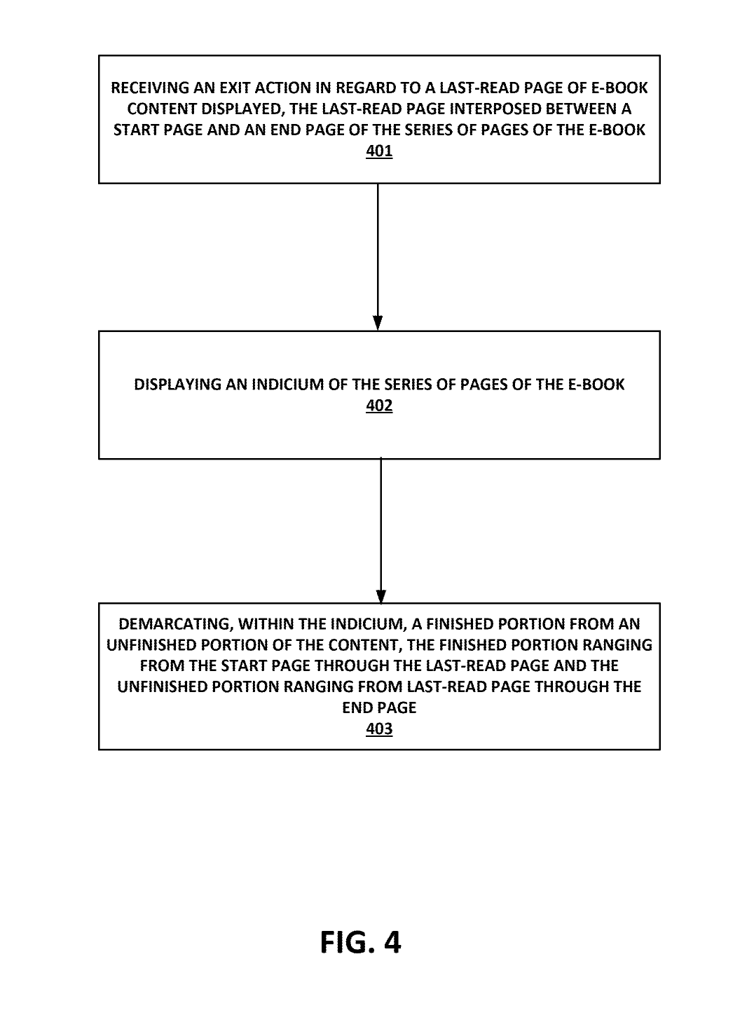

FIG. 4 illustrates an example method implemented by processor 210 of computing device 110 for providing an operation to invoke and show an e-book reading progress indicator, according to an embodiment using elements such as described with prior examples, including those of FIGS. 1-3(b) herein.

At step 401, receiving an exit action at a last-read page of e-book content displayed at display screen 116 of computing device 110, the e-book content being paginated in accordance with a series of digitally constructed pages including a start page 304 and an end page 305, the last-read page 306 interposed between the start and end pages.

At step 402, displaying an indicium 300a, 300b of the series of pages comprising the e-book.

At step 403, demarcating, within the indicium 300a, 300bn, a finished portion 301 from an unfinished portion 302 of the content, the finished portion 301 ranging from the start page 304 through the last-read page and the unfinished portion 302 ranging from last-read page through the end page 305.

Although illustrative embodiments have been described in detail herein with reference to the accompanying drawings, variations to specific embodiments and details are contemplated and encompassed by this disclosure. For instance, the term e-book as used herein is intended to include e-magazines and e-comics. Further by way of example variations, although the unfinished portion of the content is described above as comprising a portion ranging from a last-read page through the end page, it is contemplated that in other embodiments the unfinished portion may range from a page subsequent to the last read page through the end page; or that the finished portion may range from a start page through a page just before the bookmarked page where the exit action is performed. In other embodiments, the start page may be variously defined as any one of the e-book cover image, a table of content page, or a first page of substantive content, for example, the first page of a first chapter.

It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen, the method comprising:
receiving an exit action at a last-read page of e-book content displayed, the e-book content being paginated in accordance with a series of digitally constructed pages including a start page and an end page, the last-read page interposed between the start and end pages;
displaying an indicium of the series of pages; and
demarcating, within the indicium, a finished portion from an unfinished portion of the content, the finished portion ranging from the start page through the last-read page and the unfinished portion ranging from last-read page through the end page.

2. The method of claim 1 wherein the indicium is provided with an image representing a cover of the e-book.

3. The method of claim 1 wherein the finished portion is displayed in proportion to the unfinished portion according to the series of digitally constructed pages contained respectively therein.

4. The method of claim 1 wherein finished portion is demarcated from the unfinished portion in accordance with a visual discontinuity.

5. The method of claim 4 wherein the discontinuity is a transition in one of: a color, a brightness and a shading.

6. The method of claim 4 wherein the visual discontinuity comprises a spatial gap between the finished and unfinished portions of the e-book content.

7. The method of claim 4 wherein the visual discontinuity comprises a transition from a static image to a pulsating image.

8. The method of claim 1 wherein the exit action comprises a bookmark action performed on the last-read page of the e-book content.

9. The method of claim 8 wherein the display screen is a touch screen and the bookmark action is performed via a touch action upon the last-read page.

10. The method of claim 1 wherein the exit action consists of one of: closing the e-book, returning to a library view, opening an application unrelated to reading the content of the e-book and switching the computing device to an off-state.

11. A computer-readable medium that stores instructions for a computing device, the computing device including a processor, a memory and a display screen, the instructions being executable by the processor to cause the computing device to perform operations that include:
receiving an exit action at a last-read page of e-book content displayed, the e-book content being paginated in accordance with a series of digitally constructed pages including a start page and an end page, the last-read page interposed between the start and end pages;
displaying an indicium of the series of pages; and
demarcating, within the indicium, a finished portion from an unfinished portion of the content, the finished portion ranging from the start page through the last-read page and the unfinished portion ranging from last-read page through the end page.

12. A computing device comprising:
a memory that stores a set of instructions;
a display screen;
a processor that access the instructions in memory, the processor further configured to:
receive an exit action at a last-read page of e-book content displayed, the e-book content being paginated in accordance with a series of digitally constructed pages including a start page and an end page, the last-read page interposed between the start and end pages;
display an indicium of the series of pages; and
demarcate, within the indicium, a finished portion from an unfinished portion of the content, the finished portion ranging from the start page through the last-read page and the unfinished portion ranging from last-read page through the end page.

13. The computing device of claim 12 wherein the indicium is provided with an image representing a cover of the e-book.

14. The computing device of claim 12 wherein the finished portion is displayed in proportion to the unfinished portion according to the series of digitally constructed pages contained respectively therein.

15. The computing device of claim 12 wherein the finished portion is demarcated from the unfinished portion in accordance with a visual discontinuity.

16. The computing device of claim 15 wherein the discontinuity is a transition in one of: a color, a brightness and a shading.

17. The computing device of claim 15 wherein the visual discontinuity comprises a spatial gap between the finished and unfinished portions of the e-book content.

18. The computing device of claim 15 wherein the visual discontinuity comprises a transition from a static image to a pulsating image.

19. The computing device of claim 12 wherein the exit action comprises a bookmark action performed on the last-read page of the e-book content.

20. The computing device of claim 19 wherein the display screen is a touch screen and the bookmark action is performed via a touch action upon the last-read page.

21. The computing device of claim 12 wherein the exit action consists of one of: closing the e-book, returning to a library view, opening an application unrelated to reading the content of the e-book and switching the computing device to an off-state.
